(19) United States
(12) Patent Application Publication
(10) Pub. No.: US 2024/0028053 A1
(43) Pub. Date: Jan. 25, 2024

(54) CONFIRMATION OF CARBON-EQUIVALENT OFFSETS FROM CONTRAIL REDUCTION AND MARKET EXCHANGE FOR SAME

(71) Applicant: George Mason University, Fairfax, VA (US)

(72) Inventor: Lance SHERRY, Fairfax, VA (US)

(21) Appl. No.: 18/223,190

(22) Filed: Jul. 18, 2023

Related U.S. Application Data
(60) Provisional application No. 63/390,434, filed on Jul. 19, 2022.

(51) Int. Cl. G05D 1/10; G08G 5/00; G06Q 30/018

(52) U.S. Cl. CPC G05D 1/106; G08G 5/0039; G06Q 30/018; G06Q 10/02

(57) ABSTRACT

In accordance with one aspect, a system for facilitating carbon-equivalent offsets from contrails includes at least one processor and at least one memory storing instructions. The instructions, when executed by the at least one processor, cause the system at least to: identify a flight designated for a contrail reduction procedure; determine, after the flight is completed, whether the flight executed the contrail reduction procedure and achieved contrail reduction; and based on determining that the flight executed the contrail reduction procedure and achieved contrail reduction, include, in a carbon offset exchange service, a carbon-equivalent offset listing corresponding to the flight.

### CROSS-REFERENCE TO RELATED APPLICATIONS

The present application claims priority to U.S. Provisional Application No. 63/390,434, filed Jul. 19, 2022, which is hereby incorporated by reference herein in its entirety.

### TECHNICAL FIELD

The present disclosure relates to carbon-equivalent offsets, and more particularly, to carbon-equivalent offsets from contrail reduction.

### BACKGROUND

Contrails, also known as aircraft induced clouds (AIC), are ice crystal clouds formed at high altitudes as the result of jet engine emissions. In specific atmospheric conditions, known as ice super saturated (ISS) regions, when there is high humidity and low temperatures, water vapor emitted by the jet engines adheres to soot particles, also emitted by the jet engine, forming ice crystals that grow and form cirrus-like clouds.

These anthropogenic (i.e., human-made) clouds have the property that they reflect back to Earth the outgoing “thermal” radiation emitted by the Earth. This reflection back to earth upsets the Earth's energy balance resulting in an increase in surface and atmospheric temperatures resulting in global warming.

Various estimates attribute 2% of the Earths radiation imbalance to aircraft induced clouds/contrails. The remaining 98% is the result of greenhouse gases (GHGs) such as CO₂ and methane that also mix into the atmosphere and reflect back to Earth outgoing thermal radiation.

Estimates show that 55% of the aviation's anthropogenic global heating is from contrails and 35% is from CO₂ emitted from the jet engines. Whereas CO₂ emissions tend to affect the climate over a long term (e.g., in 20-40 years), contrails have an immediate effect on the Earth's temperature structure.

### SUMMARY

The present disclosure relates to carbon-equivalent offsets from contrail reduction. Aspects of the present disclosure are directed to confirming a carbon-equivalent offset, for a flight that has been designated for a contrail reduction procedure, by confirming that the flight executed the contrail reduction procedure. Aspects of the present disclosure provide an exchange platform for listing and transacting carbon-equivalent offsets from contrail reduction.

In accordance with aspects of the present disclosure, a system for facilitating carbon-equivalent offsets from contrails includes at least one processor and at least one memory storing instructions. The instructions, when executed by the at least one processor, cause the system at least to: identify a flight designated for a contrail reduction procedure; determine, after the flight is completed, whether the flight executed the contrail reduction procedure and achieved contrail reduction; and based on determining that the flight executed the contrail reduction procedure and achieved contrail reduction, include, in a carbon offset exchange service, a carbon-equivalent offset listing corresponding to the flight.

In various embodiments of the system, in determining whether the flight executed the contrail reduction procedure and achieved contrail reduction, the instructions, when executed by the at least one processor, cause the system at least to: access at least one of: flight track data for a flight path of the flight, atmospheric data relating to the flight path, or imagery of the flight path; and determine whether the flight executed the contrail reduction procedure and achieved contrail reduction based on at least one of: the flight track data for the flight path, the atmospheric data relating to the flight path, or the imagery of the flight path.

In various embodiments of the system, in determining whether the flight executed the contrail reduction procedure and achieved contrail reduction, the instructions, when executed by the at least one processor, cause the system at least to: determine, based on the atmospheric data relating to the flight, whether the flight avoided an atmospheric ice super saturated (ISS) region.

In various embodiments of the system, in determining whether the flight avoided an atmospheric ISS region, the instructions, when executed by the at least one processor, cause the system at least to: apply a contrail formation model and a contrail persistence model to the atmospheric data relating to the flight.

In various embodiments of the system, the instructions, when executed by the at least one processor, further cause the system at least to: receive a plurality of scheduled flights; determine at least one scheduled flight, among the plurality of the scheduled flights, which is a candidate for contrail reduction; and communicate the at least one scheduled flight.

In various embodiments of the system, in determining the at least one scheduled flight, among the plurality of the scheduled flights, which is a candidate for contrail reduction, the instructions, when executed by the at least one processor, further cause the system at least to: access atmospheric forecast data relating to the plurality of scheduled flights; and for each scheduled flight of the plurality of scheduled flights: determine, based on the atmospheric forecast data and at least one contrail model, whether a cruising altitude adjustment for the respective scheduled flight would result in a contrail reduction, and in case of determining that the cruising altitude adjustment for the respective scheduled flight would result in a contrail reduction, include the respective scheduled flight in the at least one scheduled flight which is a candidate for contrail reduction.

In various embodiments of the system, the instructions, when executed by the at least one processor, further cause the system at least to: provide the carbon offset exchange service; and execute, in the carbon offset exchange service, at least one transaction for the carbon-equivalent offset listing corresponding to the flight, the at least one transaction comprising at least one of: accepting at least one bid for the carbon-equivalent offset, or transferring the carbon-equivalent offset to a purchaser.

In accordance with aspects of the present disclosure, a method for facilitating carbon-equivalent offsets from contrails includes: identifying a flight designated for a contrail reduction procedure; determining, after the flight is completed, whether the flight executed the contrail reduction procedure and achieved contrail reduction; and based on determining that the flight executed the contrail reduction procedure and achieved contrail reduction, including, in a carbon offset exchange service, a carbon-equivalent offset listing corresponding to the flight.

In various embodiments of the method, determining whether the flight executed the contrail reduction procedure and achieved contrail reduction includes: accessing at least one of: flight track data for a flight path of the flight, atmospheric data relating to the flight path, or imagery of the flight path; and determining whether the flight executed the contrail reduction procedure and achieved contrail reduction based on at least one of: the flight track data for the flight path, the atmospheric data relating to the flight path, or the imagery of the flight path.

In various embodiments of the method, determining whether the flight executed the contrail reduction procedure and achieved contrail reduction includes determining, based on the atmospheric data relating to the flight, whether the flight avoided an atmospheric ice super saturated (ISS) region.

In various embodiments of the method, determining whether the flight avoided an atmospheric ISS region includes: applying a contrail formation model and a contrail persistence model to the atmospheric data relating to the flight.

In various embodiments of the method, the method further includes: receiving a plurality of scheduled flights; determining at least one scheduled flight, among the plurality of the scheduled flights, which is a candidate for contrail reduction; and communicating the at least one scheduled flight.

In various embodiments of the method, determining the at least one scheduled flight, among the plurality of the scheduled flights, which is a candidate for contrail reduction, includes: accessing atmospheric forecast data relating to the plurality of scheduled flights; and for each scheduled flight of the plurality of scheduled flights: determining, based on the atmospheric forecast data and at least one contrail model, whether a cruising altitude adjustment for the respective scheduled flight would result in a contrail reduction, and in case of determining that the cruising altitude adjustment for the respective scheduled flight would result in a contrail reduction, including the respective scheduled flight in the at least one scheduled flight which is a candidate for contrail reduction.

In various embodiments of the method, the method further includes: providing the carbon offset exchange service; and executing, in the carbon offset exchange service, at least one transaction for the carbon-equivalent offset listing corresponding to the flight, the at least one transaction comprising at least one of: accepting at least one bid for the carbon-equivalent offset, or transferring the carbon-equivalent offset to a purchaser.

In accordance with aspects of the present disclosure, a processor-readable medium stores instructions which, when executed by at least one processor of a system, cause the system at least to: identify a flight designated for a contrail reduction procedure; determine, after the flight is completed, whether the flight executed the contrail reduction procedure and achieved contrail reduction; and based on determining that the flight executed the contrail reduction procedure and achieved contrail reduction, include, in a carbon offset exchange service, a carbon-equivalent offset listing corresponding to the flight.

In various embodiments of the processor-readable medium, determining whether the flight executed the contrail reduction procedure and achieved contrail reduction includes: accessing at least one of: flight track data for a flight path of the flight, atmospheric data relating to the flight path, or imagery of the flight path; and determining whether the flight executed the contrail reduction procedure and achieved contrail reduction based on at least one of: the flight track data for the flight path, the atmospheric data relating to the flight path, or the imagery of the flight path.

In various embodiments of the processor-readable medium, determining whether the flight executed the contrail reduction procedure and achieved contrail reduction includes determining, based on the atmospheric data relating to the flight, whether the flight avoided an atmospheric ice super saturated (ISS) region.

In various embodiments of the processor-readable medium, determining whether the flight avoided an atmospheric ISS region includes: applying a contrail formation model and a contrail persistence model to the atmospheric data relating to the flight.

In various embodiments of the processor-readable medium, the instructions, when executed by the at least one processor, further cause the system at least to: receive a plurality of scheduled flights; determine at least one scheduled flight, among the plurality of the scheduled flights, which is a candidate for contrail reduction; and communicate the at least one scheduled flight.

In various embodiments of the processor-readable medium, determining the at least one scheduled flight, among the plurality of the scheduled flights, which is a candidate for contrail reduction, includes: accessing atmospheric forecast data relating to the plurality of scheduled flights; and for each scheduled flight of the plurality of scheduled flights: determining, based on the atmospheric forecast data and at least one contrail model, whether a cruising altitude adjustment for the respective scheduled flight would result in a contrail reduction, and in case of determining that the cruising altitude adjustment for the respective scheduled flight would result in a contrail reduction, including the respective scheduled flight in the at least one scheduled flight which is a candidate for contrail reduction.

In various embodiments of the processor-readable medium, the instructions, when executed by the at least one processor, further cause the system at least to: provide the carbon offset exchange service; and execute, in the carbon offset exchange service, at least one transaction for the carbon-equivalent offset listing corresponding to the flight, the at least one transaction comprising at least one of: accepting at least one bid for the carbon-equivalent offset, or transferring the carbon-equivalent offset to a purchaser.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1A and FIG. 1B are a block diagram of an example of a platform and environment for listing and transacting carbon-equivalent offsets from contrail reduction, in accordance with aspects of the present disclosure;

FIG. 2A and FIG. 2B are a block diagram of an example of interactions and operations of a platform that lists and transacts carbon-equivalent offsets from contrail reduction, in accordance with aspects of the present disclosure;

FIG. 3 is a flow diagram of example operations of a system that confirms and lists carbon-equivalent offsets from contrail reduction, in accordance with aspects of the present disclosure;

FIG. 4 is a block diagram of example components of a system that provides at least a portion of the platform and services of FIGS. 1-3, in accordance with aspects of the present disclosure;

FIG. 5 is a diagram of an example grid of atmospheric data, in accordance with aspects of the present disclosure;

FIG. 6 is an example of a satellite image showing contrails, in accordance with aspects of the present disclosure; and

FIG. 7 is an example of a terrestrial image showing contrails, in accordance with aspects of the present disclosure.

### DETAILED DESCRIPTION

The present disclosure relates to carbon-equivalent offsets from contrail reduction. Aspects of the present disclosure are directed to confirming a carbon-equivalent offset, for a flight that has been designated for a contrail reduction procedure, by confirming that the flight executed the contrail reduction procedure. Aspects of the present disclosure provide an exchange platform for listing and transacting carbon-equivalent offsets from contrail reduction. The terms “contrail”, “aircraft induced cloud”, and “AIC” may be used interchangeably.

There have been proposals to avoid the generation of contrails. One proposal involves raising aircraft cruise flight levels by 1,000-2,000 feet to avoid flying through ice super saturated (ISS) regions. It is estimated that such higher aircraft cruise flight levels will effect, on average, only 15% of the flights per day in the National Airspace System (NAS) and will require additional fuel burn of just less than 1% per flight in the NAS. Estimates show that, in most cases, flights at the higher aircraft cruising level would impose no additional fuel burn or enroute time because the additional cost (e.g., fuel burn) of ascending to a higher aircraft cruising flight level is offset by reduced drag at the higher altitude, which results in lower fuel burn. And since only a small percentage of flights (on average 15% per day) generate contrails, adjusting aircraft cruising levels for the small percentage of flights would not create additional air traffic control congestion or workload.

Aspects of the present disclosure provide an exchange platform for listing and transacting carbon-equivalent offsets from contrail reduction. In various embodiments, a carbon-equivalent offset from contrail reduction may represent the equivalent amount of CO₂ reduction that would result in the same climate benefit (e.g., radiation savings) provided by the contrail reduction. In various embodiments, a carbon-equivalent offset from contrail reduction may represent other carbon reduction quantities that would result in the same climate benefit provided by the contrail reduction. Persons skilled in the art will recognize such other carbon reduction quantities. The description herein may refer to CO₂-equivalent offset as an example of carbon-equivalent offset, and the CO₂-equivalent offset may be referred to by the term “eCO2 offset.” It is intended that any description referring to “eCO2 offset” shall be treated as though the same description referred to carbon-equivalent offset in general.

An exchange platform allows airlines to earn money by taking intentional actions to reduce generation of contrails. Buyers of the carbon-equivalent offsets could be other airlines or other entities seeking to offset greenhouse gas emissions. In various embodiments, the exchange platform may also provide a secondary market for parties that have purchased the carbon-equivalent offsets to sell them, thereby providing liquidity for the carbon-equivalent offsets and further incentivizing airlines to generate them.

Aspects of the present disclosure relate to establishing legitimacy of the carbon-equivalent offsets generated by contrail reduction actions. As will be explained in more detail below, in various embodiments, this legitimacy may be established by using a contrail formation model, a contrail persistence model, and a contrail net radiative forcing model, together with flight track data, predicted and actual atmospheric data, and/or satellite images and/or terrestrial images. In various embodiments, for carbon-equivalent offsets that are deemed to be legitimate, the carbon-equivalent offset may be certified and designated as unique property for exchange and may be exchanged between sellers and buyers of carbon-equivalent offsets.

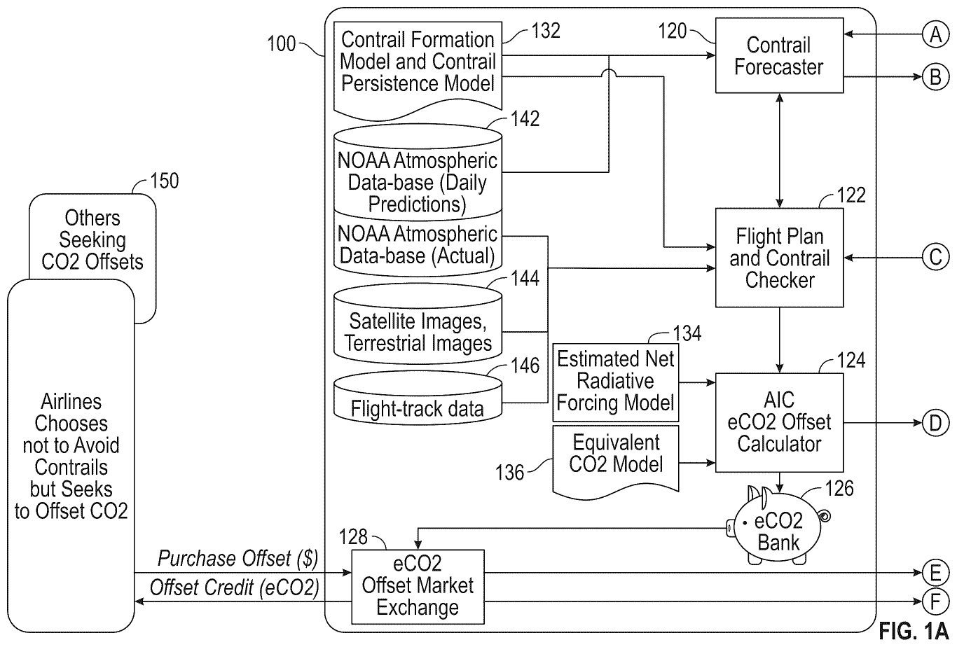

Referring to FIG. 1A and FIG. 1B, there is shown a block diagram of an example platform and environment for listing and transacting carbon-equivalent offsets from contrail reduction. The environment includes one or more airliners 110 that interact with the platform 100 to generate carbon-equivalent offsets from contrail reductions and includes other entities or airliners 150 that interact with the platform 100 to purchase the carbon-equivalent offsets.

The airliner 110 may be an airline company or flight operator company. Airlines and other flight operators are free to plan flights to transit the airspace. Each flight is required to “file” a flight plan with the Air Navigation Service Provider (ANSP). The flight plan takes into account aircraft performance with the intended payload and fuel (e.g., rate of climb, max cruising flight level), atmospheric conditions (e.g., jet stream and other wind, temperature, weather disturbances such as thunderstorms, etc.), and expected traffic loads. With regard to airspace operations (not airports), the ANSP will generally accept the proposed flight route as-is. In some circumstances, when the airspace is closed or when the airspace capacity is less than the demand, the route can be amended. Flight plans may be filed from three (3) hours before departure until the time of departure. Once the flight is airborne, the flight plan can only be amended within the performance constraints of the aircraft (e.g., maximum cruise flight level) and fuel endurance.

In accordance with aspects of the present disclosure, the platform 100 provides various services to the airliner 110, which may be an airliner with intention to avoid contrails and use or sell CO₂ offsets. The platform 100 may be implemented as a standalone system, a distributed system, a cloud-based system, or some combination of these, among other implementations. Although the platform is illustrated in FIG. 1A and FIG. 1B with many components, in various embodiments, certain components may be third party components that are outside the platform 100 and that may be accessed by the platform 100 via third party systems, such as via application programming interfaces (APIs) and/or data subscription feeds, among other possibilities. For example, in various embodiments, one or more of the databases 142, 144, 146 and/or one or more of the services 120-128 may be provided by third parties. Such variations and contemplated to be within the scope of the present disclosure.

The platform 100 provides various services, including an aircraft induced cloud (AIC) forecaster 120, a flight plan and contrail checker 122, an AIC carbon-equivalent offset calculator 124, a carbon-equivalent offset ledger/bank 126, and a carbon-equivalent offset exchange service 128. Each of the services may be implemented by processor-readable instructions which provide the services when the instructions are executed by one or more processors. Altogether, the services 120-128 collaborate to designate certain scheduled flights for a contrail reduction procedure, check whether the designated flights executed the contrail reduction procedure and achieved contrail reduction, compute carbon-equivalent offsets for the designated flights that executed the contrail reduction procedure, and list the carbon-equivalent offsets in an exchange and execute transactions for the listed carbon-equivalent offsets. Each of the services 120-128 is described below.

The contrail forecaster 120 is a service that determines which flights may be candidates for contrail reduction. The airliner 110 may communicate a list of flight plans for scheduled flights to the contrail forecaster 120. In the illustrated embodiment, the scheduled flights are flights scheduled for the following day. In various embodiments, the scheduled flights may be flights scheduled for the same day or may be flights scheduled for another time period, such as flights scheduled for the next twelve hours, or the next six hours, or another time period. For each of the scheduled flights, the contrail forecaster 120 determines whether the scheduled flight may generate a contrail and, if so, whether the contrail may be reduced (e.g., reduced partially or completely) by an operational change in the flight plan, such as by increasing or decreasing the aircraft cruising flight level by 2,000 feet, 4,000 feet, etc., among other possible operational changes.

The contrail forecaster 120 may determine which flights may be candidates for contrail reduction by using a contrail formation model and contrail persistence model 132 and an atmospheric database 142 which contains atmospheric forecasts/predictions (e.g., database from National Oceanic and Atmospheric Administration). The contrail formation model and contrail persistence model 132 may take the flight plans and the atmospheric forecasts/predictions as inputs and may determine an AIC that would be generated by each flight plan, as well as a cruising flight level adjustment that would reduce the AIC. Further aspects of the contrail formation model and contrail persistence model 132 will be described in more detail below herein. The atmospheric database 142 may include atmospheric forecasts that enable the contrail formation model and contrail persistence model 132 to forecast the presence of one or more ISS regions along a flight path and determine whether a cruising flight level adjustment (e.g., increase or decrease of 2,000 feet, 4,000 feet, etc.) would avoid the ISS region(s). Scheduled flights for which a cruising flight level adjustment is predicted to avoid one or more ISS regions become candidates for contrail reduction, and the contrail forecaster 120 communicates the scheduled flights which are candidates for contrail reduction to the airliner 110.

In the illustrated embodiment, the contrail forecaster 120 uses a cruising flight level adjustment of +2,000 feet to determine flight plans for which the cruising flight level adjustment is forecast to result in contrail reduction. In various embodiments, the contrail forecaster 120 may use one or more other cruising flight level adjustment values (e.g., increase or decrease by 2,000 feet, 4,000 feet, etc.) and/or use other operational adjustments (e.g., change of flight path) to forecast contrail reduction. Such embodiments are contemplated to be within the scope of the present disclosure.

In the illustrated embodiment, the platform 100 (e.g., the contrail forecaster 120 or the AIC carbon-equivalent offset calculator 124) may communicate, to the airliner 110, an estimated monetary value for the expected carbon-equivalent offset. The AIC carbon-equivalent offset calculator 124 will be described below herein.

Accordingly, the airliner 110 receives, from the platform 100, a listing of scheduled flights which are candidates for a contrail reduction procedure and receives the proposed operational adjustment that would achieve the contrail reduction. The airliner 110 may also receive, from the platform 100, an estimated monetary value for the expected carbon-equivalent offset. Based on this information, the airliner 110 may decide which flights (if any) should executed a contrail reduction procedure and may designate one or more flights for contrail reduction procedure (e.g., cruising flight level adjustment or otherwise). If any flights are designated, the airliner 110 communicates, to the platform 100 (e.g., the flight plan and contrail checker 122), a list of one or more flights designated for contrail reduction procedure. The flight plan and contrail checker 122 will now be described.

On the day of a flight, the airliner 110 executes the flight. The flight plan and contrail checker 122 is a service that determines whether a flight that was designated for contrail reduction procedure (e.g., cruising flight level adjustment or otherwise) has executed the contrail reduction procedure and achieved contrail reduction. The flight plan and contrail checker 122 may determine whether a flight executed a contrail reduction procedure by using flight track data from a flight track database 146. The flight track data may be provided by services such as ADS-B Exchange, among other services. Using the flight track data, the flight plan and contrail checker 122 may determine whether a flight executed a contrail reduction procedure, such as a cruising flight level adjustment.

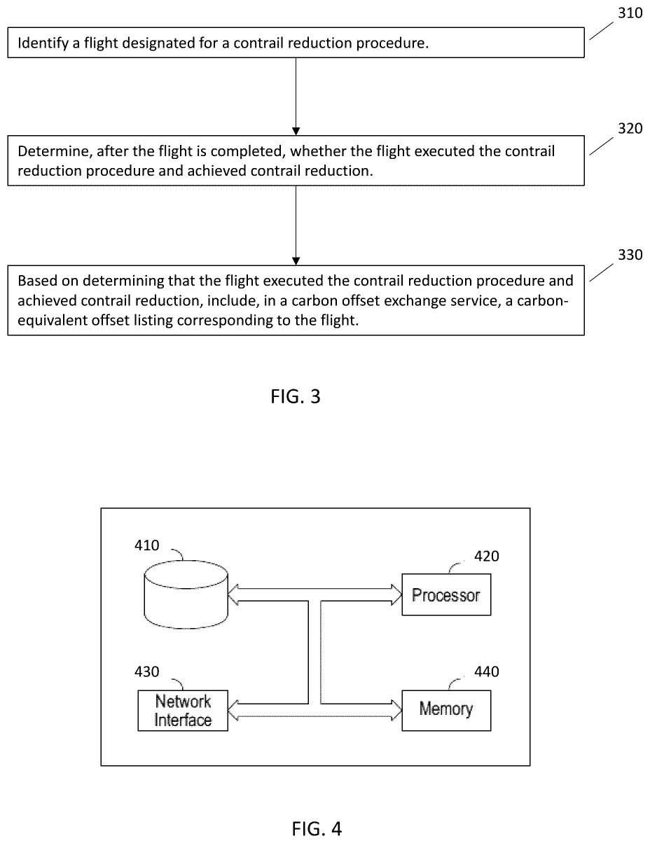

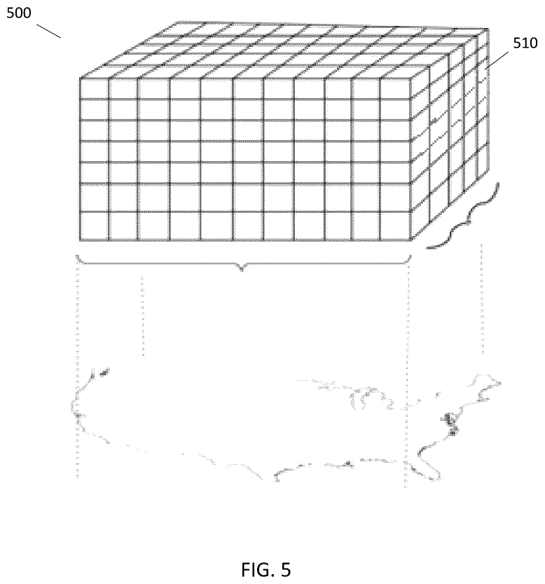

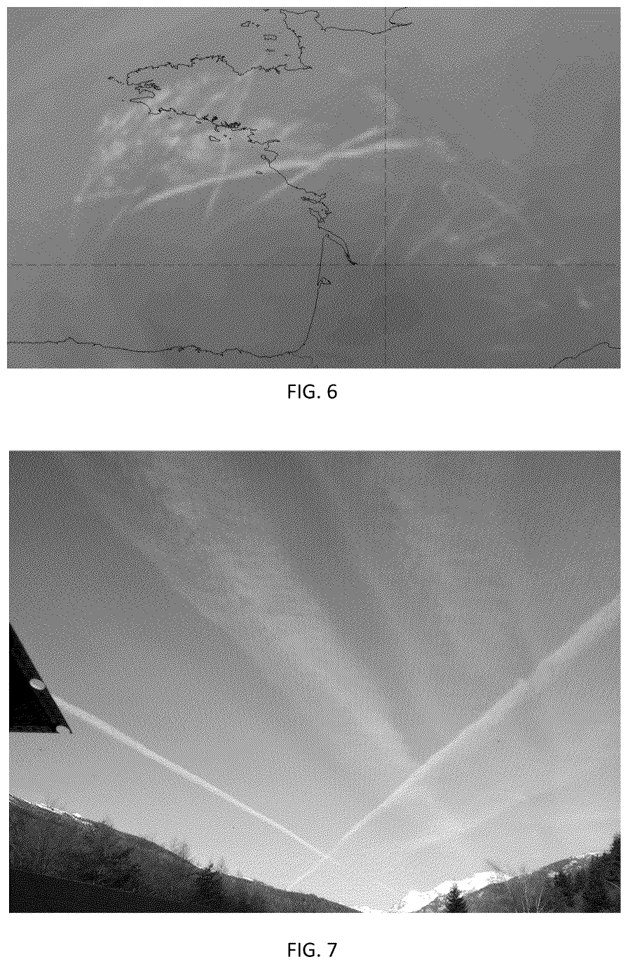

In accordance with aspects of the present disclosure, the flight plan and contrail checker 122 also operates to confirm contrail reduction using one or more of actual atmospheric data 142 relating to a flight path and/or satellite images and/or terrestrial images 144 of the flight path. Using actual atmospheric data 142 relating to a flight path (e.g., atmospheric data from National Oceanic and Atmospheric Administration), the flight plan and contrail checker 122 may apply the contrail formation model and contrail persistence model 132 to the actual atmospheric data 142 to determine ISS regions (if any) along a flight path and confirm whether or not the flight avoided at least a portion of the ISS regions. Using satellite images and/or terrestrial images 144 of a flight path, the flight plan and contrail checker 122 may use image processing and/or machine vision (e.g., a trained convolutional neural network) to analyze the images of the flight path and confirm absence of contrails along at least a portion of the flight path that avoids ISS regions. The contrail formation model and contrail persistence model 132 will be described in more detail in connection with FIG. 5. An example of a satellite image showing contrails is provided in FIG. 6, and an example of a terrestrial image showing contrails is provided in FIG. 7. In various embodiments, terrestrial images of flight paths may be provided by networks of ground-based image capture devices. The satellite image and the terrestrial image are merely examples, and other satellite images and other terrestrial images are contemplated to be within the scope of the present disclosure.

In accordance with aspects of the present disclosure, in case the flight plan and contrail checker 122 determines that a flight avoided at least a portion of ISS regions and/or satellite images and/or terrestrial images show a lack of contrails along at least a portion of a flight path, the flight plan and contrail checker 122 and/or the contrail forecaster 120 may determine an amount of contrail that was reduced (e.g., partially or wholly reduced). The flight plan and contrail checker 122 and/or the contrail forecaster 120 may apply the contrail formation model and contrail persistence model 132 to the actual atmospheric data 142 for the original, unadjusted flight path to determine the contrail that would have been formed by the original, unadjusted flight path. The flight plan and contrail checker 122 and/or the contrail forecaster 120 may provide, to the AIC carbon-equivalent offset calculator 124, contrail reduction information on a difference between the contrail that would have been formed by the original, unadjusted flight path and the reduced contrail (e.g., reduced to zero) that resulted from the adjusted flight path. In various embodiments, the contrail reduction information may include a difference between the contrail distance that would have been formed by the original, unadjusted flight path and the reduced contrail distance (e.g., reduced to zero) that resulted from the adjusted flight path, which will be referred to herein as a contrail reduction distance.

The AIC carbon-equivalent offset calculator 124 is a service that determines the carbon-equivalent offset corresponding to a contrail reduction procedure for a flight. As described above, the AIC carbon-equivalent offset calculator 124 may receive contrail reduction information on a difference between the contrail that would have been formed by the original, unadjusted flight path and the contrail (or absence thereof) that resulted from the adjusted flight path, e.g., the contrail reduction distance. The AIC carbon-equivalent offset calculator 124 may apply an estimated net radiative forcing model 134 and an equivalent CO₂ model 136 to determine the carbon-equivalent offset for the flight. The estimated net radiative forcing model 134 operates to determine the amount of radiation that reflects into space instead of being trapped by a contrail. The estimated net radiative forcing model 134 is applied to the contrail reduction information to determine the amount of radiation that reflects into space, instead of being trapped, as a result of the modified flight plan, and the equivalent CO₂ model determines the carbon-equivalent offset for that amount of radiation. As mentioned above, the carbon-equivalent offset from contrail reduction may represent the equivalent amount of CO₂ reduction that would result in the same climate benefit (e.g., radiation savings) provided by the contrail reduction.

After determining the carbon-equivalent offset, the AIC carbon-equivalent offset calculator 124 provides the carbon-equivalent offset to the carbon offset bank/ledger 126, which keeps accounts of carbon-equivalent offsets owned by the airliner 110 or by other parties. In various embodiments, the carbon offset bank/ledger 126 may determine and maintain a value of each carbon-equivalent offset, which may be a market value.

The carbon-equivalent offsets in the carbon offset bank/ledger 126 may be listed and transacted on a carbon offset market exchange service 128. In various embodiments, the carbon offset exchange service 128 may have the same functionality as a securities exchange or brokerage platform, such as functionality allowing buyers and sellers to set bid and ask prices for the carbon-equivalent offsets, functionality for determining a market value for the carbon-equivalent offsets based on the bid and ask prices, and functionality for reflecting purchases and sales of the carbon-equivalent offsets. In various embodiments, purchases and sales of the carbon-equivalent offsets may be reflected in the carbon offset bank/ledger 126 in the accounts of the purchasers and sellers.

Other airliners or other entities 150 (which may choose not to avoid contrails) may seek to offset carbon emissions by using the carbon offset exchange service 128 to browse the listed carbon-equivalent offsets and to bid on the listed carbon-equivalent offsets. For any carbon-equivalent offsets purchased, the other airliners or other entities 150 may transmit the purchase amount to the carbon offset exchange service 128, which may transfer the purchase amount to the airliner 110 which generated the carbon-equivalent offset. In various embodiments, the carbon offset exchange service 128 may retain a portion of the purchase amount as a service fee, or may charge a transaction fee to the purchaser and/or the seller.

Accordingly, the services 120-128 and their interactions with the airliner 110 and other airliners or entities 150 were described above. Although the services 120-128 are illustrated in FIG. 1A as separate services, various of the services 120-128 or portions of the services 120-128 may be combined or may be separated. In various embodiments, some of the services (e.g., contrail forecaster 120) or portions thereof may be accessed by the airliner 110 using application programming interfaces. In various embodiments, some of the services or portions thereof may be provided by third parties, rather than all of the services being provided by a single platform 100. Such and other embodiments are contemplated to be within the scope of the present disclosure.

The following describe further details of some examples of the models 132-136 and the databases 142-146. The following examples are merely illustrative and do not limit the scope of the present disclosure.

With continuing reference to FIG. 1A, the contrail formation model and contrail persistence model 132 may apply various models that persons skilled in the art will recognize. The contrail formation model determines whether a contrail would form, and the contrail persistence model determines how long a contrail may persist after forming. The contrail formation model may apply a model as described in Schumann, U., A. J. Heymsfield, “On the Life Cycle of Individual Contrails and Contrail Cirrus”, Meteorological Monographs—Ice Formation and Evolution in Clouds and Precipitation: Measurement and Modeling Challenges, Vol. 58, Issue 1, pages 3.1-3.24 (2017), which is hereby incorporated by reference herein in its entirety. The contrail persistence model may apply a model as described in Avila, D., Sherry, L., Thompson, T, “Reducing Global Warming by Airline Contrail Avoidance: A Case Study of Annual Benefits for the Contiguous United States”, Transportation Research Interdisciplinary Perspectives, Vol. 2, p. 100033 (September, 2019), which is hereby incorporated by reference herein in its entirety.

As a summary, the contrail formation model may use what is known as the Schmidt-Appleman criterion to identify contrail formation in certain atmospheric conditions that give rise to ice-supersaturated (ISS) regions. The atmospheric conditions may be identified using atmospheric data from the atmospheric database 142. In various embodiments, the atmospheric data may be organized in a grid format (e.g., as shown in FIG. 5), such as atmospheric data provided by the National Oceanic and Atmospheric Administration (“NOAA”). With reference also to FIG. 5, the Schmidt-Appleman criterion may be applied to a cell of the grid 500 to determine whether a contrail may form in that cell. Using atmospheric data from NOAA as an example, the atmospheric data may provide temperature and relative humidity for water, among other data, for a cell, such as cell 510. Such atmospheric data may be converted to relative humidity for ice, using conversion formulas that persons skilled in the art will recognize, and such data may be used in connection with the Schmidt-Appleman criterion to determine whether the cell 510 includes an ISS region that supports contrail formation. The grid 500 and the cell 510 are merely examples, and the contrail formation model may be applied to any grid, any cell of any grid, any number of grids, and/or any number of cells.

Continuing with grid 500 as an example, the grid 500 may be used to determine a contrail (or absence thereof) of a flight path that traverses the grid 500. In various embodiments, the flight path through the grid 500 may be determined, and then the contrail formation model and contrail persistence model may be applied to such cells. In various embodiments, the contrail formation model may be applied to each cell of the grid 500 to determine which cells have ISS regions, and then the cells which have ISS regions and which are traversed by a flight path may be further processed by the contrail persistence model. Because the atmospheric data for the grid 500 changes over time and a flight takes time to traverse the grid 500, earlier atmospheric data may be used for certain cells in a flight path and later atmospheric data may be used for certain cells in the flight path. Additionally, the contrail persistence model may use atmospheric data over time to determine the duration of a contrail. For example, the contrail persistence model may consider whether relative humidity for ice and other atmospheric conditions have changed over time or are forecast to change over time. Thus, atmospheric data that changes over time may be used by the contrail formation model and the contrail persistence model 132.

With continuing reference to FIG. 1A, the estimated net radiative forcing model 134 operates to determine the radiation savings corresponding to a contrail reduction. Generally, the term “radiative forcing” refers to what happens when the amount of energy that enters the Earth's atmosphere is different from the amount of energy that leaves the Earth's atmosphere. In various embodiments, the estimated net radiative forcing model 134 may apply a model as described in U. Schumann, “A Contrail Cirrus Prediction Model”, Geoscientific Model Development, Vol. 5, Issue 3, pages 543-580 (2012), which is hereby incorporated by reference herein in its entirety. The contrail cirrus prediction model may be referred to as the CoCiP model. As a summary, the CoCiP model may consider optical depth, contrail reduction distance, and sun azimuth angle, among other potential data, to determine the net radiative forcing corresponding to the contrail reduction procedure.

With continuing reference to FIG. 1A, the equivalent CO₂ model 136 may apply a model as described in E. A. Irvine et al., “A simple framework for assessing the trade-off between the climate impact of aviation carbon dioxide emissions and contrails for a single flight”, Environmental Research Letters, Vol. 9, No. 064021, pages 1-6 (2014), which is hereby incorporated by reference herein in its entirety. As a summary, the equivalent CO₂ model 136 may compute a quantity known as an absolute global warming potential (AGWP). In various embodiments, the AGWP may be based on a particular time period, such as 20 years, or 50 years, or 100 years, or other time periods.

Accordingly, various models 132-136 have been described above. The models described above herein are merely examples, and other models are contemplated to be within the scope of the present disclosure.

FIG. 1A and FIG. 1B and their corresponding description are merely illustrative, and variations are contemplated to be within the scope of the present disclosure. In various embodiments, the platform 100 may include other components not shown in FIG. 1A or FIG. 1B. In various embodiments, the platform 100 may not include all of the components shown in FIG. 1A and/or FIG. 1B. In various embodiments, the platform 100 may have different connections than those shown in FIG. 1A and/or FIG. 1B. Such and other variations are contemplated to be within the scope of the present disclosure.

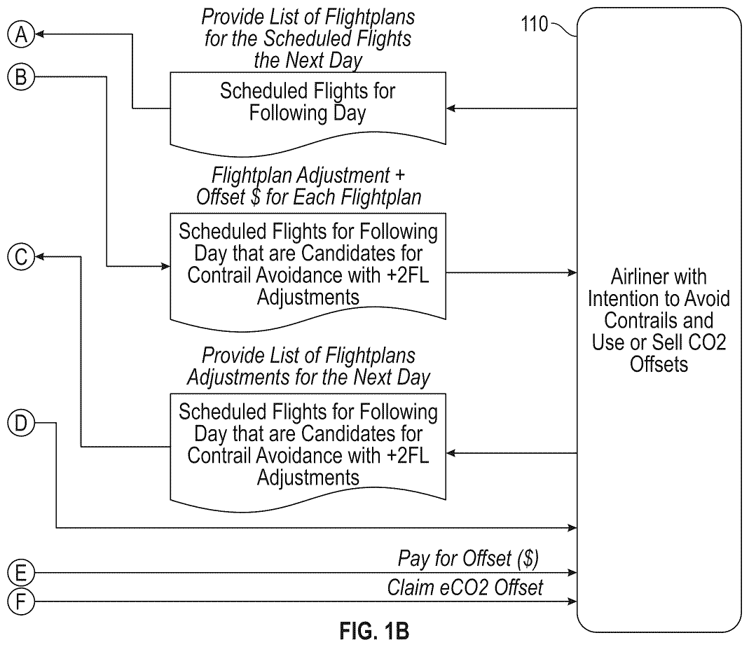

Referring now to FIG. 2A and FIG. 2B, there is shown a diagram of an example of interactions and operations of a platform that lists and transacts carbon-equivalent offsets from contrail reduction. Illustrated at the top of the diagram are the services 120-128 of the platform, the airliner 110 which intends to avoid contrails, and the other entities 150 which seek to purchase carbon offsets are also illustrated. Interactions and operations of these services and parties are illustrated by interactions and operations 201-213. The models 132-136 and the databases 142-146 are also illustrated near the interactions and operations where they are used.

At interaction 201, the airliner 110 communicates, to the contrail forecaster 120, a list of scheduled flights, and the contrail forecaster 120 receives the list of scheduled flights. At described above, the schedule flights are illustrated as flights scheduled for the following day, which is merely an example. In various embodiments, the flights may be scheduled for the same day, for the next six hours, for the next four hours, or for another time period. After interaction 201, the contrail forecaster 120 accesses the atmospheric database 142 and applies the contrail formation model and contrail persistence model 132 to determine scheduled flights which are candidates for a contrail reduction procedure, as described above herein.

At interaction 202, the contrail forecaster 120 communicates, to the airliner 110, the scheduled flights which are candidates for a contrail reduction procedure, along with the corresponding contrail reduction procedure (e.g., increasing or decreasing cruising flight level by 2,000 feet or 4,000 feet, among other adjustments), and the airliner 110 receives such information. In various embodiments, the contrail forecaster 120 or the contrail carbon-equivalent offset calculator 124 may communicate, to the airliner 110, an estimated monetary value of predicted carbon-equivalent offsets from contrail reduction, as described above herein.

After interaction 202, the airliner 110 decides whether to designate certain scheduled flights for contrail reduction procedure. For example, the airliner 110 may decide to designate flights which have a sufficiently large estimated monetary value of predicted carbon-equivalent offsets from the contrail reduction procedure (e.g., estimated monetary value above a threshold value). In various embodiments, the airliner 110 may use other criteria to select and designate scheduled flights for contrail reduction procedure. For example, the airliner 110 may designate flights for contrail reduction procedure whenever additional fuel burn for the contrail reduction procedures is negligible, among other criteria.

At interaction 203, the airliner 110 communicates, to the flight plan and contrail checker 122, the list of scheduled flights which are designated for contrail reduction procedure, and the flight plan and contrail checker 122 receives the list of designated flights.

At interaction 204, the airliner 110 operates the flights, and flight tracking data is collected and stored in the flight track database 146. As mentioned above, in various embodiments, the flight track database 146 may be provided by third party services, such as ADS-B Exchange, among other services. In various embodiments, the flight track database 146 may be proprietary to the platform but may be populated by data feeds from third party databases.

After interaction 204, the flight plan and contrail checker 122 operates to determine whether a flight that was designated for contrail reduction procedure (e.g., cruising flight level adjustment or otherwise) has executed the contrail reduction procedure and achieved contrail reduction. As described above, the flight plan and contrail checker 122 may determine whether a flight executed a contrail reduction procedure by using the flight track data from the flight track database 146. The flight plan and contrail checker 122 also operates to confirm contrail reduction using one or both of actual atmospheric data 142 relating to a flight path and/or satellite images and/or terrestrial images 144 of the flight path, as described above herein.

In case the flight plan and contrail checker 122 determines that a flight avoided at least a portion of ISS regions and/or satellite images and/or terrestrial images show a lack of contrails along at least a portion of a flight path, the flight plan and contrail checker 122 and/or the contrail forecaster 120 may determine an amount or percentage of contrail that was reduced (e.g., partially or wholly reduced), as described above herein.

At interaction 205, the flight plan and contrail checker 122 and/or the contrail forecaster 120 may provide or communicate, to the AIC carbon-equivalent offset calculator 124, contrail reduction information on a difference between the contrail that would have been formed by the original, unadjusted flight path and the contrail (or absence thereof) that resulted from the adjusted flight path, and the AIC carbon-equivalent offset calculator 124 receives such information.

After interaction 205, the AIC carbon-equivalent offset calculator 124 determines the carbon-equivalent offset corresponding to a contrail reduction procedure for a flight. The AIC carbon-equivalent offset calculator 124 may apply an estimated net radiative forcing model 134 and an equivalent CO₂ model 136 to determine the carbon-equivalent offset for the flight, as described above herein.

At interaction 206, the AIC carbon-equivalent offset calculator 124 provides or communicates the carbon-equivalent offsets to the carbon offset bank/ledger 126, which keeps accounts of carbon-equivalent offsets owned by the airliner 110 or by other parties, and the carbon offset bank/ledger 126 receives the carbon-equivalent offsets.

At interaction 207, the carbon offset bank/ledger 126 provides or communicates the carbon-equivalent offsets to the carbon offset exchange service 128 to be listed and transacted, and the carbon offset exchange service 128 receives the carbon-equivalent offsets.

At interaction 208, the entities 150 seeking to offset carbon emissions communicate bids for a carbon-equivalent offset to the carbon offset exchange service 128.

After interaction 208, the carbon offset exchange service 128 may evaluate the bid in the same manner that a securities exchange evaluates bids, such as evaluate whether there is sufficient overlap between bid and ask prices. A bid may be rejected, for example, if it does not overlap with any ask prices or if it is not a winning bid. In various embodiments, the carbon offset exchange service 128 may implement other criteria for accepting or rejecting bids, such as implementing a purchase limit for individual accounts, e.g., per day limit or per week limit or a limit for another time period, for example. Such and other criteria for accepting or rejecting bids are contemplated to be within the scope of the present disclosure.

At interaction 209, the carbon offset exchange service 128 informs the entity 150 whether the bid was accepted or rejected. FIG. 2A and FIG. 2B proceed on the assumption that the bid was accepted. Assuming the bid is accepted, then at interaction 210, the entity 150 purchases the carbon-equivalent offset and communicates payment of the purchase amount to the carbon offset exchange service 128, and the carbon offset exchange service 128 receives the payment.

At interaction 211, the carbon offset exchange service 128 communicates the purchase amount to the airliner 110 which generated the carbon-equivalent offset, and the airliner 110 receives the purchase amount.

At interaction 212, the carbon offset exchange service 128 communicates the purchase to the carbon offset ledger/bank 126, which updates its records to reflect the purchase and change of ownership by debiting the account of the airliner 110 and crediting the account of the purchasing entity 150. At interaction 213, the carbon offset ledger/bank 126 communicates the crediting of the purchasing entity's account to the entity 150.

Accordingly, the interactions of FIG. 2A and FIG. 2B provide a system for confirming that contrail reduction occurred, thereby providing legitimacy for carbon-equivalent offsets from contrail reduction. The interactions provide an exchange service for listing and transaction carbon-equivalent offsets from contrail reduction, which provides a liquid market for such carbon-equivalent offsets and incentivizes airlines to take contrail reduction procedures.

FIG. 2A and FIG. 2B and their corresponding description are merely illustrative, and variations are contemplated to be within the scope of the present disclosure. In various embodiments, the interactions may include other interactions not shown in FIG. 2A or FIG. 2B. In various embodiments, the interactions may not include all of the interactions shown in FIG. 2A and/or FIG. 2B. In various embodiments, the interactions may have a different order than those shown in FIG. 2A and/or FIG. 2B. Such and other variations are contemplated to be within the scope of the present disclosure.

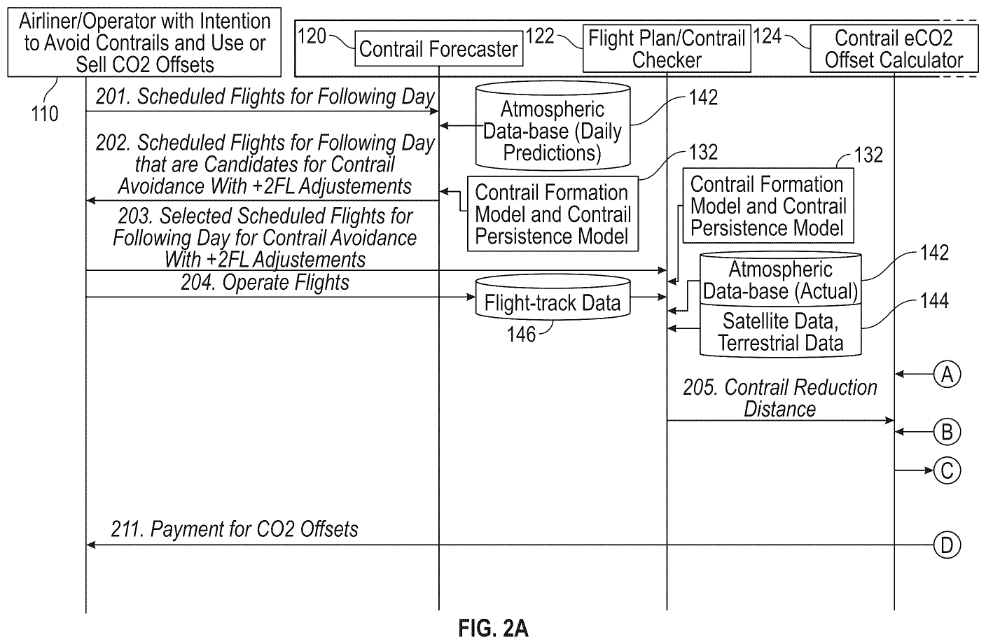

FIG. 3 is a flow diagram of example operations of a system that confirms and lists carbon-equivalent offsets from contrail reduction. The operations of FIG. 3 may be a subset of the operations described in connection with FIG. 1A, FIG. 1B, FIG. 2A, and/or FIG. 2B. Prior to the operations of FIG. 3, an airline has already designated scheduled flights for contrail reduction procedures.

At block 310, the operation involves identifying a flight designated for a contrail reduction procedure. For example, the operation of block 310 may identify one of the flights communicated in interaction 203 of FIG. 2A.

At block 320, the operation involves determining, after the flight is completed, whether the flight executed the contrail reduction procedure and achieved contrail reduction. The operation of block 320 may involve the operations described in connection the flight plan and contrail checker 122 of FIG. 1A and FIG. 2A. In particular, the operation of block 320 may determine whether a flight executed a contrail reduction procedure by using flight track data from a flight track database 146 and may also confirm whether contrail reduction was achieved using one or both of actual atmospheric data relating to a flight path and/or satellite images and/or terrestrial images of the flight path, as described above herein.

At block 330, the operation involves, based on determining that the flight executed the contrail reduction procedure and achieved contrail reduction, include, in a carbon offset exchange service, a carbon-equivalent offset listing corresponding to the flight. The carbon offset exchange service may be the service 128 of FIG. 1A and FIG. 2B, for example. After a carbon-equivalent offset is listed in the carbon offset exchange service, it can be transacted in various ways, such as begin bid upon and purchased by a purchaser.

FIG. 3 is merely illustrative, and variations are contemplated to be within the scope of the present disclosure. In various embodiments, the operations may include other operations not shown in FIG. 3. In various embodiments, the operations may not include all of the operations shown in FIG. 3. Such and other variations are contemplated to be within the scope of the present disclosure.

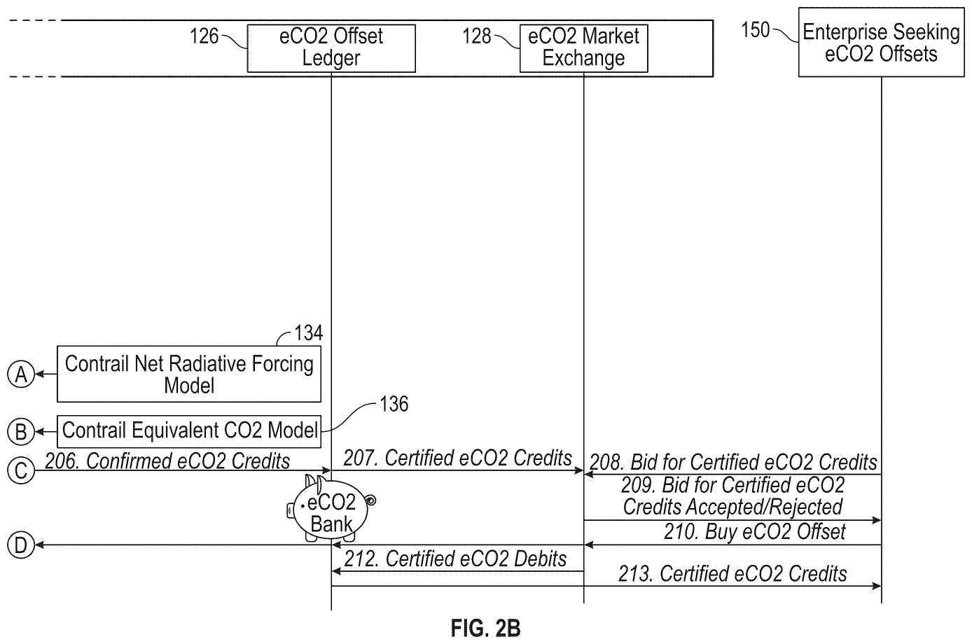

FIG. 4 is a block diagram of example components of a system that provides any portion of the platform or any portion of the services described herein. The system includes an electronic storage 410, a processor 420, a memory 450, and a network interface 440. The various components may be communicatively coupled with each other. The processor 420 may be and may include any type of processor, such as a single-core central processing unit (CPU), a multi-core CPU, a microprocessor, a digital signal processor (DSP), a System-on-Chip (SoC), or any other type of processor. The memory 450 may be a volatile type of memory, e.g., RAM, or a non-volatile type of memory, e.g., NAND flash memory. The memory 450 includes processor-readable instructions that are executable by the processor 420 to cause the system to perform various operations, including those mentioned herein, such as the operations described in connection with of FIG. 1A, FIG. 1B, FIG. 2A, and/or FIG. 2B.

The electronic storage 410 may be and include any type of electronic storage used for storing data, such as hard disk drive, solid state drive, and/or optical disc, among other types of electronic storage. The electronic storage 410 stores processor-readable instructions for causing the system to perform its operations and stores data associated with such operations, such as storing data relating to any of the databases 142-146 or relating to carbon-equivalent offsets from contrail reduction, among other data. The network interface 440 may implement networking technologies, such as Ethernet, Wi-Fi, and/or other wireless networking technologies.

The components shown in FIG. 4 are merely examples, and persons skilled in the art will understand that a system includes other components not illustrated and may include multiples of any of the illustrated components. Such and other embodiments are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A system for facilitating carbon-equivalent offsets from contrails, the system comprising:
at least one processor; and
at least one memory storing instructions which, when executed by the at least one processor, cause the system at least to:
identify a flight designated for a contrail reduction procedure;
determine, after the flight is completed, whether the flight executed the contrail reduction procedure and achieved contrail reduction; and
based on determining that the flight executed the contrail reduction procedure and achieved contrail reduction, include, in a carbon offset exchange service, a carbon-equivalent offset listing corresponding to the flight.

2. The system of claim 1, wherein in determining whether the flight executed the contrail reduction procedure and achieved contrail reduction, the instructions, when executed by the at least one processor, cause the system at least to:
access at least one of: flight track data for a flight path of the flight, atmospheric data relating to the flight path, or imagery of the flight path; and
determine whether the flight executed the contrail reduction procedure and achieved contrail reduction based on at least one of: the flight track data for the flight path, the atmospheric data relating to the flight path, or the imagery of the flight path.

3. The system of claim 2, wherein in determining whether the flight executed the contrail reduction procedure and achieved contrail reduction, the instructions, when executed by the at least one processor, cause the system at least to: determine, based on the atmospheric data relating to the flight, whether the flight avoided an atmospheric ice super saturated (ISS) region.

4. The system of claim 3, wherein in determining whether the flight avoided an atmospheric ISS region, the instructions, when executed by the at least one processor, cause the system at least to:
apply a contrail formation model and a contrail persistence model to the atmospheric data relating to the flight.

5. The system of claim 1, wherein the instructions, when executed by the at least one processor, further cause the system at least to:
receive a plurality of scheduled flights;
determine at least one scheduled flight, among the plurality of the scheduled flights, which is a candidate for contrail reduction; and
communicate the at least one scheduled flight.

6. The system of claim 5, wherein in determining the at least one scheduled flight, among the plurality of the scheduled flights, which is a candidate for contrail reduction, the instructions, when executed by the at least one processor, further cause the system at least to:
access atmospheric forecast data relating to the plurality of scheduled flights; and
for each scheduled flight of the plurality of scheduled flights:
determine, based on the atmospheric forecast data and at least one contrail model, whether a cruising altitude adjustment for the respective scheduled flight would result in a contrail reduction, and
in case of determining that the cruising altitude adjustment for the respective scheduled flight would result in a contrail reduction, include the respective scheduled flight in the at least one scheduled flight which is a candidate for contrail reduction.

7. The system of claim 1, wherein the instructions, when executed by the at least one processor, further cause the system at least to:
provide the carbon offset exchange service; and
execute, in the carbon offset exchange service, at least one transaction for the carbon-equivalent offset listing corresponding to the flight, the at least one transaction comprising at least one of:
accepting at least one bid for the carbon-equivalent offset, or
transferring the carbon-equivalent offset to a purchaser.

8. A method for facilitating carbon-equivalent offsets from contrails, the method comprising:
identifying a flight designated for a contrail reduction procedure;
determining, after the flight is completed, whether the flight executed the contrail reduction procedure and achieved contrail reduction; and
based on determining that the flight executed the contrail reduction procedure and achieved contrail reduction, including, in a carbon offset exchange service, a carbon-equivalent offset listing corresponding to the flight.

9. The method of claim 8, wherein determining whether the flight executed the contrail reduction procedure and achieved contrail reduction comprises:
accessing at least one of: flight track data for a flight path of the flight, atmospheric data relating to the flight path, or imagery of the flight path; and
determining whether the flight executed the contrail reduction procedure and achieved contrail reduction based on at least one of: the flight track data for the flight path, the atmospheric data relating to the flight path, or the imagery of the flight path.

10. The method of claim 9, wherein determining whether the flight executed the contrail reduction procedure and achieved contrail reduction comprises determining, based on the atmospheric data relating to the flight, whether the flight avoided an atmospheric ice super saturated (ISS) region.

11. The method of claim 10, wherein determining whether the flight avoided an atmospheric ISS region comprises:
applying a contrail formation model and a contrail persistence model to the atmospheric data relating to the flight.

12. The method of claim 8, further comprising:
receiving a plurality of scheduled flights;
determining at least one scheduled flight, among the plurality of the scheduled flights, which is a candidate for contrail reduction; and
communicating the at least one scheduled flight.

13. The method of claim 12, wherein determining the at least one scheduled flight, among the plurality of the scheduled flights, which is a candidate for contrail reduction, comprises:
accessing atmospheric forecast data relating to the plurality of scheduled flights; and
for each scheduled flight of the plurality of scheduled flights:
determining, based on the atmospheric forecast data and at least one contrail model, whether a cruising altitude adjustment for the respective scheduled flight would result in a contrail reduction, and
in case of determining that the cruising altitude adjustment for the respective scheduled flight would result in a contrail reduction, including the respective scheduled flight in the at least one scheduled flight which is a candidate for contrail reduction.

14. The method of claim 8, further comprising:
providing the carbon offset exchange service; and
executing, in the carbon offset exchange service, at least one transaction for the carbon-equivalent offset listing corresponding to the flight, the at least one transaction comprising at least one of:
accepting at least one bid for the carbon-equivalent offset, or
transferring the carbon-equivalent offset to a purchaser.

15. A processor-readable medium storing instructions which, when executed by at least one processor of a system, cause the system at least to:
identify a flight designated for a contrail reduction procedure;
determine, after the flight is completed, whether the flight executed the contrail reduction procedure and achieved contrail reduction; and
based on determining that the flight executed the contrail reduction procedure and achieved contrail reduction, include, in a carbon offset exchange service, a carbon-equivalent offset listing corresponding to the flight.

16. The processor-readable medium of claim 15, wherein determining whether the flight executed the contrail reduction procedure and achieved contrail reduction comprises:
accessing at least one of: flight track data for a flight path of the flight, atmospheric data relating to the flight path, or imagery of the flight path; and
determining whether the flight executed the contrail reduction procedure and achieved contrail reduction based on at least one of: the flight track data for the flight path, the atmospheric data relating to the flight path, or the imagery of the flight path.

17. The processor-readable medium of claim 16, wherein determining whether the flight executed the contrail reduction procedure and achieved contrail reduction comprises determining, based on the atmospheric data relating to the flight, whether the flight avoided an atmospheric ice super saturated (ISS) region.

18. The processor-readable medium of claim 17, wherein determining whether the flight avoided an atmospheric ISS region comprises:
applying a contrail formation model and a contrail persistence model to the atmospheric data relating to the flight.

19. The processor-readable medium of claim 15, wherein the instructions, when executed by the at least one processor, further cause the system at least to:
receive a plurality of scheduled flights;
determine at least one scheduled flight, among the plurality of the scheduled flights, which is a candidate for contrail reduction; and
communicate the at least one scheduled flight.

20. The processor-readable medium of claim 19, wherein determining the at least one scheduled flight, among the plurality of the scheduled flights, which is a candidate for contrail reduction, comprises:
accessing atmospheric forecast data relating to the plurality of scheduled flights; and
for each scheduled flight of the plurality of scheduled flights:
determining, based on the atmospheric forecast data and at least one contrail model, whether a cruising altitude adjustment for the respective scheduled flight would result in a contrail reduction, and
in case of determining that the cruising altitude adjustment for the respective scheduled flight would result in a contrail reduction, including the respective scheduled flight in the at least one scheduled flight which is a candidate for contrail reduction.

21. The processor-readable medium of claim 15, wherein the instructions, when executed by the at least one processor, further cause the system at least to:
provide the carbon offset exchange service; and
execute, in the carbon offset exchange service, at least one transaction for the carbon-equivalent offset listing corresponding to the flight, the at least one transaction comprising at least one of:
accepting at least one bid for the carbon-equivalent offset, or
transferring the carbon-equivalent offset to a purchaser.
